(19) United States
(12) Patent Application Publication
(10) Pub. No.: US 2011/0180951 A1
(43) Pub. Date: Jul. 28, 2011

(54) FIBER STRUCTURES AND PROCESS FOR THEIR PREPARATION

(76) Inventors: Wee Eong Teo, Singapore (SG); Kwan-Ho Casey Chan, Singapore (SG); Kazutoshi Fujihara, Singapore (SG); Seeram Ramakrishna, Singapore (SG); Susan Liao, Singapore (SG)

(21) Appl. No.: 12/441,072

(22) PCT Filed: Sep. 18, 2007
(86) PCT No.: PCT/SG2007/000315

§ 371 Date: Mar. 12, 2009

Related U.S. Application Data
(60) Provisional application No. 60/845,318, filed on Sep. 18, 2006.
(60) Provisional application No. 60/962,763, filed on Jul. 31, 2007.

(51) Int. Cl. B27N 3/04; B28B 13/00

(52) U.S. Cl. 264/109; 425/71

(57) ABSTRACT

There is provided a process of preparing at least one fiber structure comprising: (a) contacting at least one viscous material with at least one non-solvent, the non-solvent having a first flow rate; and (b) allowing formation of the fiber structure in the presence of the non-solvent at a second flow rate, wherein the second flow rate is less than the first flow rate or is about zero. There is provided a process of preparing at least one fiber structure, wherein the fiber structure is a fiber scaffold, comprising: (a) contacting at least one viscous material with at least one non-solvent, the non-solvent having a first flow rate; and (b) obtaining at least one fiber and assembling the obtained fiber(s), or allowing the obtained fiber(s) to be assembled, in the form of a fiber scaffold. There is also provided a fiber structure obtainable by any process according to the invention and an apparatus for preparing a fiber structure.

### FIELD OF THE INVENTION

The present invention relates to the preparation of fiber(s), and fiber structure(s). In particular, the invention relates to fiber structures in the form of scaffold and/or layer.

### BACKGROUND OF THE INVENTION

Nanofibers have shown tremendous potential for use as biological scaffolds as they resemble natural extra-cellular matrix. Their large surface area to volume ratio also makes it a potential candidate in drug release and the incorporation of biological substances for release when used in vivo. Recently, electrospinning has been used by many researchers to fabricate nanofibrous scaffolds. The nanofibrous scaffolds have shown to encourage cell proliferation and cell adhesion. The ease of production of nanofibers and the incorporation of various substances into the nanofibers have made electrospinning an important process in the fabrication of biomimetic scaffolds.

In electrospinning, a solution with sufficient viscosity, typically, but not restricted to a polymer solution, is used as the initial raw material for fiber fabrication. A high voltage power supply is used to apply a high voltage to the solution. When the electrical force exceeds the surface tension of the solution, solution jets are ejected from the nozzle of a spinneret. As the jet travels to the collector, the size of the solution jet is shrunk to nano scale while the solvent evaporates. Electrospinning is able to produce fibers with diameter of a few microns down to the nanometer scale. Electrospun fibers are generally deposited as a largely two-dimensional non-woven scaffold on the collector. Although the scaffold has a very high porosity which is advantageous for tissue scaffolds, the pore size is generally too small to allow cell penetration beyond the surface of the electrospun scaffold. This significantly limits the application of the electrospun scaffold despite the advantages of it being biomimetic.

The main reason for the difficulty in fabricating various nanofibrous assemblies is that individual nanofibers are too weak to be physically manipulated using standard apparatus. It is also not possible to form three-dimensional scaffolds through electrospinning as the residual charges on the deposited fibers generally divert subsequent incoming fibers to the side. Since the fiber is so small, stacking of the fibers to increase the bulk during the electrospinning process would take a long time. Furthermore, the pore size between the fibers or the layers of fibers would be so small that cells would have difficulty in penetrating into the electrospun scaffold unless degradation of the fibers occurs.

EP1591569 (Kulpinski) describes a method of preparing 2D fiber structures by preparing a polymer spinning solution and providing a flowing non-solvent as a coagulating media to facilitate the collection of the electrospun nanofibers. The electrospun fibers are then wound onto rollers or other collecting devices. However, the method described in Kulpinski would not allow the collection of a thin layer of fibers. Accordingly, the filtration efficiency of the fibers prepared from the method of Kulpinski is reduced.

WO 2007/013858 describes a method of producing fibers by electrospinning. The fiber(s) produced are then spun around a rotating roller to produce fiber yarns. This method is only suitable for collecting fiber yarns and cannot fabricate three-dimensional fiber structures or two-dimensional fiber mesh.

Accordingly, there is a need in the art of new methodologies for preparing fibers and fiber structures of improved quality.

### SUMMARY OF THE INVENTION

The present invention addresses the problems above, and in particular provides new processes to prepare fibers. In particular, the invention provides new processes to prepare fiber construct(s), for example in the form of layer and/or scaffold. The invention also provides the fiber constructs prepared according to the process of the invention.

According to a first aspect, the present invention provides a process of preparing at least one fiber structure comprising the steps of:
(a) contacting at least one viscous material with at least one non-solvent, the non-solvent having a first flow rate; and
(b) allowing formation of the at least one fiber structure in the presence of the non-solvent at a second flow rate, wherein the second flow rate is less than the first flow rate or the second flow rate is about zero.

The fiber structure may be a layer of fibers. For example, the fiber structure may be a single layer or multiple layers of fibers. The layer of fibers may have a thickness of about one fiber, in particular, one fiber diameter.

Fibers of various diameters may be formed from the process of the present invention. Accordingly, the fiber structure may have a diameter of about 100 μm or less. In particular, the fiber structure may have a diameter of about 500 nm or less.

The first flow rate and second flow rate of the non-solvent may be varied and altered according to any suitable method. According to a particular aspect, the first flow rate may be obtained by allowing the non-solvent to flow down an inclined plane. For example, the degree of the incline may be varied to achieve different flow rates.

According to a particular aspect, the second flow rate may be approximately zero. Even more in particular, the second flow rate is approximately zero and the step of allowing formation of the fiber structure is performed in the presence of substantially stagnant non-solvent.

The first flow rate of the non-solvent may be reduced to a second flow rate. The manner in which the first flow rate is reduced to a second flow rate would be known to a person skilled in the art. In particular, the first flow rate is reduced to a second flow rate after the non-solvent has flowed down the inclined plane to a non-inclined plane. The fiber structure may be formed on the non-inclined plane.

According to another aspect, the present invention provides a process of preparing at least one fiber structure, wherein the fiber structure is a fiber scaffold, the process comprising the steps of:
(a) contacting at least one viscous material with at least one non-solvent, the non-solvent having a first flow rate; and
(b) obtaining at least one fiber and assembling the obtained fiber(s) to form a fiber scaffold, or allowing the obtained fiber(s) to assemble to form of a fiber scaffold.

The fiber scaffold may be formed by assembling the obtained fiber(s) or allowing the obtained fiber(s) to assemble in the presence of the non-solvent at a second flow rate, wherein the second flow rate is less than the first flow rate or the second flow rate is about zero.

The fiber scaffold may be formed by collecting the obtained fiber(s) or by allowing the obtained fiber(s) to collect. In particular, the obtained fiber(s) may be collected or allowed to collect before assembling or being allowed to assemble to form a fiber scaffold. For example, the fiber scaffold may be formed by collecting or allowing the obtained fiber(s) to collect by any suitable means.

In particular, the fiber scaffold may be formed by collecting or allowing the obtained fiber(s) to collect against a wall, barrier, mesh and/or filter.

The step of contacting at least one viscous material with at least one non-solvent in the process according to any aspect of the present invention may be performed in the presence of a vortex. The vortex may be provided by any suitable manner known in the art.

Any suitable viscous material may be used in the process of the present invention. In particular, the viscous material may comprise a polymer. The polymer may be selected from the group consisting of: polycaprolactone, polyamides, polyimides, polycarbamides, polyolefins, polyurethanes, polyethylene oxide, polylactide, poly-L-lactic acid, polygyycolide, poly(glycolic acid), polyesters, poly(vinylidene fluoride), poly(vinylidene fluoride-co-hexafluoropropylene), poly(DL-lactide), poly(L-lactide), polydioxanone, chitin, collagen either in its native form or cross-linked, silk, chitosan, poly(glutamic-co-leucine), poly-lactic-glycolide acid, poly(L-lactic acid-caprolactone), polyacrylonitrile, poly(acrylonitrile-co-methacrylate), polymethylmethacrylate, polyvinylchloride, poly(vinylidenechloride-co-acrylate), polyethylene, polypropylene, nylon series such as nylonl2 and nylon-4,6, aramid, polybenzimidazole, poly(vinyl alcohol), cellulose, cellulose acetate, cellulose acetate butylate, polyvinyl pyrrolidone-vinyl acetates, poly(bis-(2-methoxy-ethoxyethoxy))phosphazene (MEEP), poly(ethyleneimide), poly(ethylene succinate), poly(ethylene sulphide), poly(oxymethylene-oligo-oxyethylene), poly(propyleneoxide), poly(vinylacetate), polyaniline, poly (ethylene terephthalate), poly(hydroxy butyrate), SBS copolymer, poly(lactic acid), polypeptide, biopolymers such as protein, mixtures, copolymer and blends, copolymers and terpolymers thereof. It would be understood that other suitable polymers may also be used for the purposes of the present invention.

Any suitable non-solvent may be used in the process according to any aspect of the present invention. For example, the non-solvent may be at least one of, or a combination of water, mineral oil, liquid nitrogen and the like. Any suitable mineral oil may be used. The mineral oil may be any oil derived from a mineral source such as petroleum.

The non-solvent may comprise at least one additive. For example, the additive may be selected from the group consisting of: amino acids, growth factors, vitamins, hormones, cytokines, binding agents, cells, sugars, proteins and colouring dyes.

The process according to any aspect of the present invention may further comprise a step of seeding at least one cell on the fiber structure. In particular, the step of seeding at least one cell is performed on the obtained fiber(s) before the obtained fiber(s) are assembled, or allowed to assemble, to form a fiber scaffold.

Another aspect of the present invention provides a fiber structure obtained from or obtainable by any process of the invention. The fiber structure may further comprise at least one seeded cell. The fiber structure may be used as a tissue scaffold for tissue engineering.

The present invention also provides an apparatus for preparing at least one fiber construct, comprising:
(a) means for preparing at least one viscous material;
(b) means for providing at least one flowing non-solvent;
(c) means for contacting or allowing the contact of the viscous material and the non-solvent, thereby allowing the preparation of fiber(s); and
(d) a collector for collecting a fiber structure obtained by assembling the fiber in the form of a fiber structure or for collecting a fiber structure prepared by allowing the fiber to be assembled in the form of a fiber structure.

The apparatus may further comprise means for providing a vortex to the non-solvent. The means for contacting or allowing the contact of the viscous material and the non-solvent may further comprise at least one inclined plane for allowing the non-solvent to flow down the inclined plane at a first flow rate. The collector may comprise at least one non-inclined plane for allowing the fiber(s) to be assembled in the form of a fiber structure in the presence of the non-solvent at a second flow rate, such that the second flow rate is less than the first flow rate or the second flow rate is about zero. The collector may also comprise at least one mesh, filter, wall, barrier and/or collector plate for assembling the fiber to form the fiber structure.

### BRIEF DESCRIPTION OF THE FIGURES

FIG. 1: Setup for production of electrospun 3-dimensional scaffold made out of fibrous yarn.

FIG. 2: (A)Three-dimensional scaffold made out of the nanofibrous yarn. (B) An SEM image of the three-dimensional scaffold showing the nanofibers that made up the yarn.

FIG. 3: (A) Poly(Vinylidene fluoride) yarn made out of electrospun fibers. (B) Cross section of Poly(Vinylidene fluoride) yarn showing solid yarn morphology. (C) Poly(caprolactone) yarn made out of electrospun fibers. (D) Cross section of Poly(caprolactone) yarn showing hollow yarn morphology.

FIG. 4: Twisted poly(caprolactone) electrospun yarn of fiber.

FIG. 5: Electrospinning with multiple spinnerets to form a mesh on the surface of the non-solvent whereby another material is deposited on the centre of the mesh which is to be encapsulated during the drawing process of the yarn into the hole at the bottom of the container.

FIG. 6: Funnel placed in the basin to facilitate and guide the yarn into the hole.

FIG. 7: Schematic of setup with flexible movable cylindrical device and movable collector for controlling deposition of the 3-dimensional scaffold.

FIG. 8: Schematic of setup with auxiliary electrode to control the deposition of the electrospinning jet onto the non-solvent.

FIG. 9: An inclined slope to create a water flow.

FIG. 10: Modified technique to create a water flow.

FIG. 11: Multiple spinnerets to deposit fibers on the inclined slope.

FIG. 12: Auxiliary electrode to direct the electrospinning jet.

FIG. 13: Modified water flow to churn the deposited fiber layer to form a 3D structure.

FIG. 14: Modified water flow over an edge to deposit 3D scaffold.

FIG. 15: A thin layer of PLGA fibers that is one fiber diameter thick.

FIG. 16: PCL 3D scaffold by meshing the thin film together in water and freeze-dried.

FIG. 17: A close-up view of the PLGA 3D scaffold.

FIG. 18: A close-up view of the PLGA 3D scaffold.

### DETAILED DESCRIPTION OF THE INVENTION

Bibliographic references mentioned in the present specification are for convenience listed in the form of a list of references and added at the end of the examples. The whole content of such bibliographic references is herein incorporated by reference.

### Definitions

“Flow” refers to the movement of a fluid, in particular the continuous movement of the fluid. For the purposes of the present invention, fluid refers to a liquid, in particular a non-solvent.

“Flow rate” (also referred to as “volumetric flow rate”) refers to the volume of fluid which passes through a given surface per unit time (for example cubic meters per second [m³ s⁻¹] in SI units). It is usually represented by the symbol Q. According to the present invention, the non-solvent is maintained at a first flow rate. However, the flow rate of the non-solvent may be adjusted (varied) to a second flow rate, wherein the second flow rate is less than the first flow rate, or the second flow rate is zero. Alternatively, the second flow rate may be greater than the first flow rate. According to a particular embodiment of the present invention the second flow rate is less than the first flow rate or is zero. Therefore, according to this embodiment, the flow of the non-solvent becomes slower after adjustment of the flow rate from the first flow rare to the second flow rate. A second flow rate of zero refers to the fluid being in relatively (substantially) still condition (also indicated as being in a relatively “stagnant” condition).

“Relatively still condition” (also referred to as “relatively stagnant condition”) of the fluid means that the fluid has a relatively low flow rate compared to the flow rate before adjustment. In particular, the flow rate may be about zero, so that the flow rate of the fluid is substantially reduced, close to zero or almost zero.

“Adjustment of the flow rate” means changing the flow rate Q from a first flow rate to a second flow rate. The adjustment may be carried out by varying any one of the element of the following formula. Given an area A, and a fluid flowing through it with uniform velocity v with an angle θ away from the perpendicular to A, the flow rate is:

Q=A·v·cos θ

Where the flow is perpendicular to the area A, that is, θ=0, the (volumetric) flow rate is given as:

Q=A·v

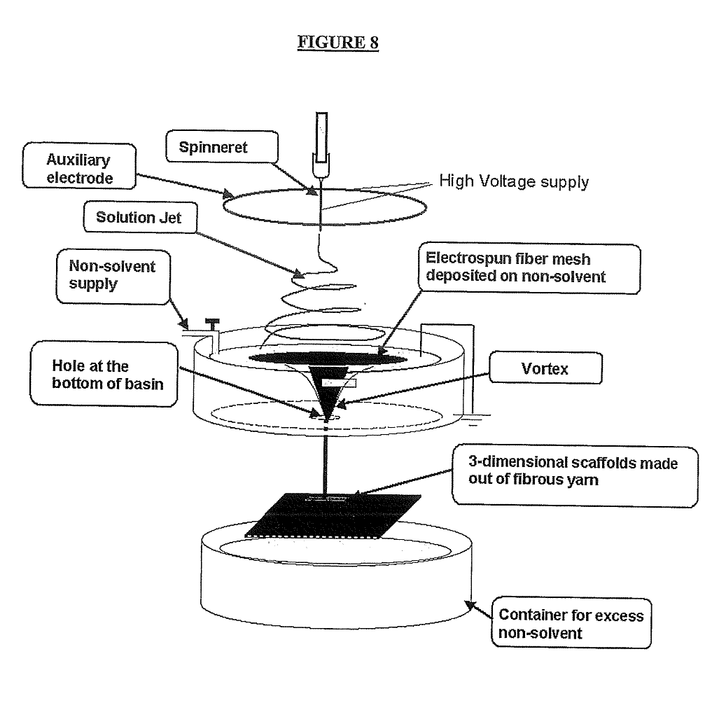

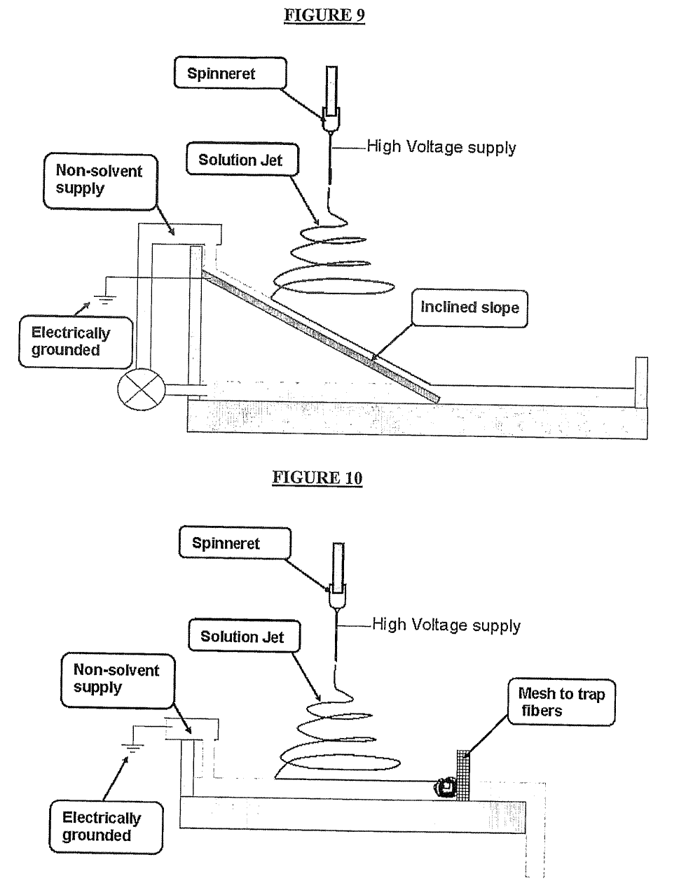

According to a particular embodiment of the invention as illustrated in FIGS. 9, 11, and 12, the viscous material (for example, a polymer solution) is contacted with a liquid (non-solvent) having a first flow rate, for example by allowing the liquid to flow down an inclined plane. The first flow rate is then adjusted to a second flow rate, wherein the second flow rate is close to zero, for example, by allowing the liquid to flow on a non-inclined plane, so that θ is about 90° or is 90°, thereby providing a substantially stagnant condition for the formation of a fiber structure.

“Fiber” refers to at least one fiber prepared according to any embodiment of the invention resulting from the contact of at least one viscous material with at least one non-solvent. In particular, the fiber may be in the form of a fiber yarn, which is used to make the fiber structure according to the invention. The fiber may have a diameter of about 300 μm or less, about 100 μm or less, about 10 μm or less, about 1000 nm or less, about 500 nm or less, about 300 nm or less, about 100 nm or less, about 50 nm or less, about 30 nm or less, about 10 nm or less. The term “fiber” encompasses “nanofiber”. The fiber according to the invention may also be referred to as (nano)fiber, thereby indicating that the fibers may either have a diameter in the pm range or in the nm range. For the purpose of the present invention, the term “nanofiber” is used to refer to a fiber having a diameter of about 10000 nm (10 μm) or less.

“Structure” or “fiber structure” according to the invention refers to any 2D and/or 3D structure formed by assembling fibers, or allowing the assembly of fibers, prepared according to the method of the invention. According to one embodiment, the invention provides a method for preparing fiber structure(s), wherein the fiber structure is in the form of “layers of fibers”, for example a thin film. In particular, the thin film may have the thickness of one fiber. Even more in particular, the thin film may have a thickness equivalent or substantially equivalent to the diameter of one fiber. The layer of fibers or thin film may also be modified to prepare a scaffold or 3D fiber structure. According to another embodiment, the invention provides a method for preparing a scaffold (also referred to as a “3D structure”, “3D fiber scaffold”, “fiber scaffold” or “scaffold”). In particular, a fiber scaffold may be formed by collecting obtained fiber(s) or allowing obtained fiber(s) to collect. Even more in particular, the obtained fiber(s) may be collected or allowed to collect against a wall, barrier, mesh and/or filter.

An “inclined plane” is a surface or plane whose endpoints are at different heights. The angle of the incline may also be varied relative to the horizontal plane. A “non-inclined plane” is a surface or plane whose endpoints are at the same height. Therefore, the angle of incline may be zero or close to zero relative to the horizontal plane. Accordingly, when a fluid flows down the inclined plane, it refers to the flow of the fluid from the endpoint which is at a higher height to the endpoint which is at a lower height.

A “viscous material” means a material (for example, a fluid) with a viscosity or internal resistance. The viscous material may be in the form of a solution (viscous solution). The viscous solution may comprise at least one polymer. The polymer may be mixed with at least one solvent. Further, the viscous solution may comprise other substances, such as nanoparticles, carbon nano-tube, salt, proteins, vitamins, sugar, and the like.

The “non-solvent” in the present invention refers to a substance which can be mixed with the “viscous material” in a certain range of proportions but is not capable of dissolving in the “viscous material”. In particular, a “non-solvent” includes any liquid that, at least partially, does not dissolve the viscous material. For example, water, mineral oil, liquid nitrogen and the like may be used as non-solvent for the purposes of the present invention. Any suitable mineral oil may be used. The mineral oil may be any oil derived from a mineral source such as petroleum.

A “vortex” refers to a substantially spiral or rotary motion of a fluid that possesses vorticity. In particular, the spiral or rotary motion of the mass of the fluid tends to draw the fluid towards its center.

### Description

Electrospinning is a method to produce fibers having a diameter from the sub-micron to the nanometer range. As a result of the size of the diameter, these fibers resemble extra cellular matrix. However, the inability to fabricate three-dimensional scaffold places a significant constraint in the application of electrospun fibers as a tissue scaffold. Other methods of fabricating three-dimensional scaffold are either not made out of nanofibers or are not versatile in terms of the materials it can be made from and the flexibility of incorporating other substances into the scaffold.

The present invention provides a process for preparing suitable fiber structures, the structures being biomimetic. The structures may have huge potential in various areas of tissue replacement and tissue engineering. Some examples include cartilage regeneration and bone regeneration. The fiber structure may be prepared from electrospun fibers and may be used to prepare three-dimensional fiber scaffolds.

The present invention describes processes for preparing fiber structures (fiber assemblies). In particular, the process involves the contacting of a viscous material with a non-solvent to allow the formation of fibers. Even more in particular, the flow profile of the non-solvent is varied to obtain various fiber (or fibrous) assemblies. By changing the flow profile of the non-solvent, the fibers can be guided to form various assemblies. Different flow profiles of the non-solvent may be used to assist in the manipulation of fibers to form various assemblies.

Accordingly, a first aspect of the present invention is a process of preparing at least one fiber structure comprising the steps of:
(a) contacting at least one viscous material with at least one non-solvent, the non-solvent having a first flow rate; and
(b) allowing formation of the at least one fiber structure in the presence of the non-solvent at a second flow rate, wherein the second flow rate is less than the first flow rate or the second flow rate is about zero.

The fiber structure may be a single fiber or multiple fibers. The fiber structure may be a layer of fibers. The fiber structure may be a single layer of fibers or multiple layers of fibers. The layer of fibers may have a thickness of about one fiber. In particular, the layer of fibers may have a thickness equivalent to about one diameter of a fiber structure. The layer of fibers may have consistent thickness. This result may not be obtained with the method described in EP1591569 (Kulpinski). For example, in the method described in Kulpinski, flow rate of the non-solvent is not varied at the points of fiber deposition and collection of resultant fiber mesh. Accordingly, it is not be possible to obtain thin layers of fibers.

The fiber structure may have a diameter ranging from a few microns to a few nanometers. The fibers should be of a small diameter, preferably between micrometers to nanometer size. For example, the fiber structure may have a diameter of about 300 μm or less, about 100 μm or less, about 10 μm or less, about 1000 nm or less, about 500 nm or less, about 300 nm or less, about 100 nm or less, about 50 nm or less, about 30 nm or less, about 10 nm or less. In particular, the fiber structure has a diameter of about 100 μm or less. Even more in particular, the fiber structure has a diameter of about 500 nm or less.

The step of contacting at least one viscous material with at least one non-solvent may comprise contacting the viscous material and the non-solvent by any suitable method. For example, the viscous material and the non-solvent may be contacted by electrospinning, melt blowing and/or pressure-assisted spinning. According to a particular embodiment, the step of contacting at least one viscous material with at least one non-solvent is achieved by electrospinning.

Any suitable electrospinning apparatus may be used. For example, the electrospinning apparatus may comprise a fluid delivery system for supplying a viscous material, a high voltage supply and a container for containing a non-solvent. The container may comprise a hole (aperture) at the bottom of the container. The fluid delivery system for electrospinning may consist of single spinneret, multiple spinnerets, co-axial spinneret, bi-capillary spinneret, multi-capillary spinneret. The spinneret is used to deliver a constant supply of viscous material. Any fluid of considerable viscosity can be electrospun. A high voltage is applied to the viscous material. At a critical voltage, a jet of solution of viscous material will be ejected from the tip of the spinneret and accelerate towards the container containing the non-solvent. Electrospinning is able to produce fibers having a diameter of a few microns down to the nanometer scale. The non-solvent may be grounded so that the electrospinning jet is more readily deposited on the surface of the non-solvent.

According to a particular aspect, the second flow rate is about zero and the step of allowing formation of the fiber structure is performed in the presence of a substantially stagnant non-solvent.

According to a particular aspect, the first flow rate is obtained by allowing the non-solvent to flow down an inclined plane. In particular, the non-solvent flows from a higher end to a lower end on the inclined plane, relative to the horizontal plane. The first flow rate may be varied by changing the angle of the incline of the inclined plane relative to the horizontal plane. For example, the larger the angle of the incline of the incline plane relative to the horizontal plane, the faster the rate of flow of the non-solvent down the inclined plane.

According to another particular aspect, the first flow rate of the non-solvent is reduced to a second flow rate. In particular, the first flow rate of the non-solvent is reduced to a second flow rate after the non-solvent has flowed down the inclined plane to a non-inclined plane, thereby allowing the fiber structure to form on the non-inclined plane. The fiber structure may form on the surface of the non-solvent and/or just below the surface of the non-solvent. According to another particular aspect, the fiber structure may be formed on the surface of the non-solvent or just below the surface of the non-solvent flowing down the inclined plane. Non-solvent from the lower end of the inclined plane may be recycled to the higher end of the inclined plane by pumping the non-solvent to the higher end.

The fiber structure may be a two-dimensional structure which may be collected or allowed to collect to form a three-dimensional fiber scaffold. In particular, the fiber structure comprised in the non-solvent may be collected or allowed to collect against a mesh, wall, barrier and/or filter. Even more in particular, the fiber structure may be removed from the non-solvent and allowed to collapse together to form a three-dimensional fibre scaffold. The fibre scaffold may be dried, for example under room conditions, or the fiber scaffold may be re-suspended in a non-solvent and freeze-dried.

According to another embodiment, the step of contacting at least one viscous material with at least one non-solvent may occur on the surface of the inclined plane along which the non-solvent is flowing down. Fibers may form at the point of contact of the viscous material with the non-solvent. The speed of the non-solvent flow down the inclined plane may be sufficiently fast such that the fibers do not accumulate along the inclined plane to form a thick layer as the flowing non-solvent would carry them away.

Another aspect of the present invention is a process of preparing at least one fiber structure, wherein the fiber structure is a fiber scaffold, the process comprising the steps of:
(a) contacting at least one viscous material with at least one non-solvent, the non-solvent having a first flow rate; and
(b) obtaining at least one fiber and assembling the obtained fiber(s) to form a fiber scaffold, or obtaining at least one fiber and allowing the obtained fiber(s) to assemble to form of a fiber scaffold.

The obtained fiber(s) may have a diameter ranging from a few microns to a few nanometers. The fiber(s) should be of a small diameter, preferably between micrometer to nanometer size. For example, the fiber(s) may have a diameter of about 300 μm or less, about 100 μm or less, about 10 μm or less, about 1000 nm or less, about 500 nm or less, about 300 nm or less, about 100 nm or less, about 50 nm or less, about 30 nm or less, about 10 nm or less. In particular, the fiber(s) has a diameter of about 100 μm or less. Even more in particular, the fiber(s) has a diameter of about 500 nm or less.

The fiber scaffold may be a three-dimensional fiber structure. According to a particular aspect, the fiber scaffold is formed by assembling the obtained fiber(s) or allowing the obtained fiber(s) to assemble on a collector. The fiber scaffold may be formed by the continuous assembly of the obtained fiber(s) on the collector. The obtained fiber(s) may be formed within the non-solvent. Accordingly, the non-solvent may also be collected on the collector. The non-solvent on the collector may be recycled back for use in the step of contacting the viscous material with the non-solvent. At least one container may be placed below the collector to collect the non-solvent or excess non-solvent from the collector.

Any suitable collector may be used. For example, the collector may be in the form of a plate or container. In particular, the collector is a collector plate. The collector may be a movable collector such that the collector moves while the obtained fiber(s) are assembling or are being allowed to assemble on the collector. The movable collector allows the obtained fiber(s) to be assembled in an ordered manner or twisted manner and accordingly, fiber scaffolds of different assemblies may be formed.

According to another particular aspect, the fiber scaffold may be formed by collecting the obtained fiber(s) or by allowing the obtained fiber(s) to collect. “Collecting” may comprise accumulating the obtained fiber(s), bundling and/or gathering the fiber(s) together, thereby forming a mass of fiber(s) or a fiber scaffold. Alternatively, the fiber(s) may be allowed to accumulate, bundle and/or gather together to form a mass of fiber or fiber scaffold. The collection of the deposited thin film or fiber(s) may be modified to obtain structures such as assemblies consisting of aligned fibers. Even more in particular, the obtained fiber(s) may be collected or allowed to collect against a wall, barrier, mesh and/or filter. For example, the obtained fiber(s) may form on the surface of the non-solvent and/or just below the surface of the non-solvent. As the non-solvent approaches the wall, barrier, mesh and/or filter, the obtained fiber(s) may be collected or allowed to collect against the wall, barrier, mesh and/or filter to form a fiber scaffold. The flow rate of the non-solvent as it approaches the wall, barrier, mesh and/or filter may be lower than the flow rate of the non-solvent when it contacts the at least one viscous material. This flow rate may be referred to as the second flow rate of the non-solvent. Accordingly, the fiber scaffold may be formed by assembling the obtained fiber(s) or allowing the obtained fiber(s) to assemble in the presence of the non-solvent at a second flow rate, wherein the second flow rate is less than the first flow rate or the second flow rate is about zero. The non-solvent may be allowed to flow through . 10 the wall, barrier, mesh and/or filter, thereby retaining the fiber(s) and allowing the fiber(s) to collect to form the fiber scaffold.

In the process according to any aspect of the present invention, the step of contacting at least one viscous material with at least one non-solvent may be carried out or performed in the presence of a vortex. The vortex may be created by any suitable method known in the state of the art. For example, the vortex may be created by using a pump or by providing a turbulent flow of the non-solvent. The speed of the vortex may be controlled by the rate at which non-solvent is pumped into the container. For example, the step of contacting at least one viscous material with at least one non-solvent may be carried out in a container. In particular, the vortex is created by pumping non-solvent into the container at a high velocity. Even more in particular, the vortex is created by pumping non-solvent from the side of the container at a high velocity.

Any suitable viscous material may be used for the purposes of the present invention. For example, the viscous material may comprise a polymer solution, polymer melt and/or ceramic precursors. The polymer solution may comprise one or more polymer, copolymer or polymer blend dissolved in a solvent and which comprises a suitable concentration of polymers. For example, a solvent with a suitable concentration of polymers is a solution that is capable of being . electrospun. Exemplary polymers include, but are not limited to, polycaprolactone, polyamides, polyimides, polycarbamides, polyolefins, polyurethanes, poly-L-lactic acid, polygyycolide, poly(DL-lactide), poly(L-lactide), polylactide, poly(glycolic acid), polyesters, polydioxanone, poly(vinylidene fluoride), poly(vinylidene fluoride-co-hexafluoropropylene), polyacrylonitrile, poly(acrylonitrile-co-methacrylate), polymethylmethacrylate, polyvinylchloride, poly(vinylidenechloride-co-acrylate), polyethylene, polypropylene, nylon series such as nylonl2 and nylon-4,6, aramid, polybenzimidazole, poly(vinyl alcohol), chitin, collagen either in its native form or cross-linked, silk, chitosan, cellulose, cellulose acetate, cellulose acetate butylate, polyvinyl pyrrolidone-vinyl acetates, poly(bis-(2-methoxy-ethoxyethoxy))phosphazene (MEEP), poly(ethyleneimide), poly(ethylene succinate), poly(ethylene sulphide), poly(oxymethylene-oligo-oxyethylene), poly(propyleneoxide), poly(vinylacetate), polyaniline, poly (ethylene terephthalate), poly(hydroxy butyrate), poly(ethylene oxide), SBS copolymer, poly(lactic acid), poly(glutamic-co-leucine), poly-lactic-glycolide acid, poly(L-lactic acid-caprolactone) copolymer, polypeptide, biopolymer such as protein, pitch series such as coal-tar pitch and petroleum pitch, and mixtures thereof. Copolymers, polymer melts and blends of the above polymers may also be used. Exemplary polymer solutions for are also disclosed in U.S. Pat. Nos. 6,790,528, 6,616,435, 6,713,011, 4,043,331 and 4,878,908. In one embodiment, the viscous material may comprise ceramic precursors. For example, a method of electrospinning ceramic precursors without polymer additives is disclosed in ‘Direct Electrospinning of Ultrafine Titania Fibres in the Absence of Polymer Additives and Formation of Pure Anatase Titania Fibres at Low Temperatures’, Son et al, Nanotechnology, 11, (2006) p439-443. The viscous material may further comprise at least one or more of the following: nanoparticles, carbon nanotubes, salt, proteins, vitamins, sugar and the like.

Any suitable non-solvent may be used for the present invention. Examples of suitable non-solvent include water, mineral oil, liquid nitrogen. The non-solvent may be a combination of non-solvents. Any suitable mineral oil may be used. The mineral oil may be any oil derived from a mineral source such as petroleum. The non-solvent may comprise additives such as amino acids, growth factors, vitamins, hormones, cytokines, binding agents, cells, sugars, proteins, colouring dyes or a combination thereof. The non-solvent may also comprise nanoparticles. The additives may be adsorbed or encapsulated on the surface of the fiber(s) to enhance the functionality of the fiber structure.

The process according to any aspect of the present invention may comprise the step of applying an electrical ground to the non-solvent during or before the step of contacting the at least one viscous material with the non-solvent. The electrical ground provides an electrical pathway to dissipate the electric charge of a subsequently formed fiber present in the non-solvent.

The process according to any aspect of the present invention may comprise the step of providing an auxiliary electrode to the viscous material as it is contacted with the non-solvent, wherein the auxiliary electrode distorts the electrostatic field of the viscous material, thereby causing it to rotate about an axis as it contacts the non-solvent. For example, the use of the auxiliary electrodes controls the flight path of the charged electrospinning viscous material. It will be appreciated that the actual spinning jet may be unstable and therefore the “rotation” is not necessarily about a fixed axis.

The process according to any aspect of the present invention may further comprise a step of seeding at least one cell on the fiber structure. For example, the step of seeding a cell may be carried out after the fiber structure is formed or on the obtained fiber(s) before the obtained fibers are assembled or allowed to assemble to form a fiber scaffold.

Another aspect of the present invention is a fiber structure obtained from or obtainable by any process of the invention described above. The fiber structure may further comprise at least one seeded cell. The fiber structure may be used as a tissue scaffold for tissue engineering.

Yet another aspect of the present invention is an apparatus for preparing at least one fiber construct, comprising:
(a) means for preparing at least one viscous material;
(b) means for providing at least one flowing non-solvent;
(c) means for contacting or allowing the contact of the viscous material and the non-solvent, thereby allowing the preparation of fiber(s); and
(d) a collector for collecting a fiber structure obtained by assembling the fiber in the form of a fiber structure or for collecting a fiber structure prepared by allowing the fiber to be assembled in the form of a fiber structure.

The apparatus may further comprise means for providing a vortex to the non-solvent. Any suitable means for providing a vortex may be used. In particular, the means for providing a vortex to the non-solvent comprises a pump.

The means for contacting or allowing the contact of the viscous material and the non-solvent may further comprise at least one inclined plane for allowing the non-solvent to flow down the inclined plane at a first flow rate.

The collector may comprise at least one non-inclined plane for allowing the fiber(s) to be assembled in the form of a fiber structure in the presence of the non-solvent at a second flow rate, such that the second flow rate is less than the first flow rate or the second flow rate is about zero. The collector may also comprise at least one mesh, filter, wall, barrier and/or collector plate for assembling the fiber to form the fiber structure.

Having now generally described the invention, the same will be more readily understood through reference to the following embodiments and Figures which are provided by way of illustration, and are not intended to be limiting of the present invention.

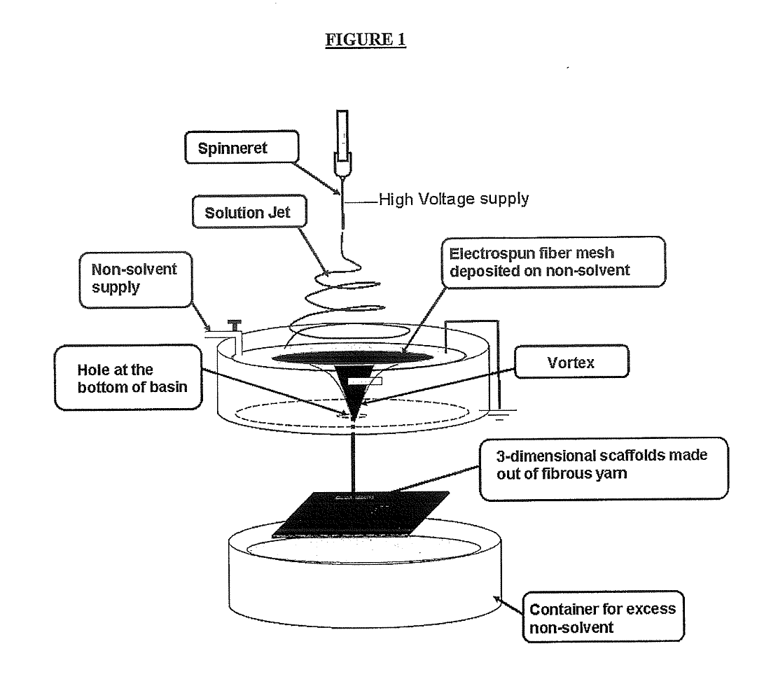

FIG. 1 shows an example of an apparatus suitable for preparing a three-dimensional fiber structure, such as a fiber scaffold. The apparatus comprises a container containing a non-solvent (also referred to as the “top container”). Non-solvent is supplied to the container by any suitable means, such as a pump. Any suitable non-solvent may be used, as described above. A spinneret is used to provide viscous material in the form of an electrospinning jet when a high voltage is supplied to the viscous material. Any suitable viscous material may be used, as described above. The container with the non-solvent is used to collect fiber mesh from the electrospinning jet. The non-solvent in the container is grounded to establish a static electric field between the spinneret and top container and to thereby form a Taylor Cone therebetween. The grounded non-solvent also allows for an electrical pathway to dissipate the electric charge of the formed fiber mesh so that the electrospinning jet is more readily deposited on the surface of the non-solvent.

A vortex is created in the non-solvent container to facilitate the drawing of the electrospun fiber mesh that is deposited on the surface of the non-solvent in the container. The vortex is created by using at least one pump. In particular, the vortex is created by pumping non-solvent into the container at a high velocity. The speed of the vortex may be controlled by the rate at which the non-solvent is pumped into the container. Another opening at the side of the container nearer to the top may be used to discharge any excess non-solvent such that the level of the non-solvent in the container is maintained.

The container containing the non-solvent has an aperture (hole) at the bottom surface to allow non-solvent and fiber mesh to flow out of the container. Another container (referred to as the “bottom container”) is placed below the top container to collect non-solvent that flows out through the hole and/or excess non-solvent which flows from the top container. The non-solvent in the bottom container may be subsequently pumped back into the top container.

It is preferred that the vortex extends into the hole at the bottom surface of the top container. For example, the vortex may be created by the natural flow of water through the hole at the bottom surface of the top container. In this way, the drawing of the electrospun fiber mesh into a yarn of fibers can be carried out automatically. This is because the electrospun fiber mesh is carried by the vortex into the hole below.

A collector plate is placed below the hole of the top container from which the yarn of fibers are drawn out together with the exiting non-solvent. Continuous deposition of the yarn of fibers on the collector plate forms a three-dimensional fiber scaffold. Alternatively, the yarn of fibers and the non-solvent may be allowed to flow from the hole in the top container into the bottom container. By allowing the yarn of fibers to collect in the bottom container, a three-dimensional fiber scaffold is formed. As mentioned above, the non-solvent collected in the bottom container may be pumped back into the top container.

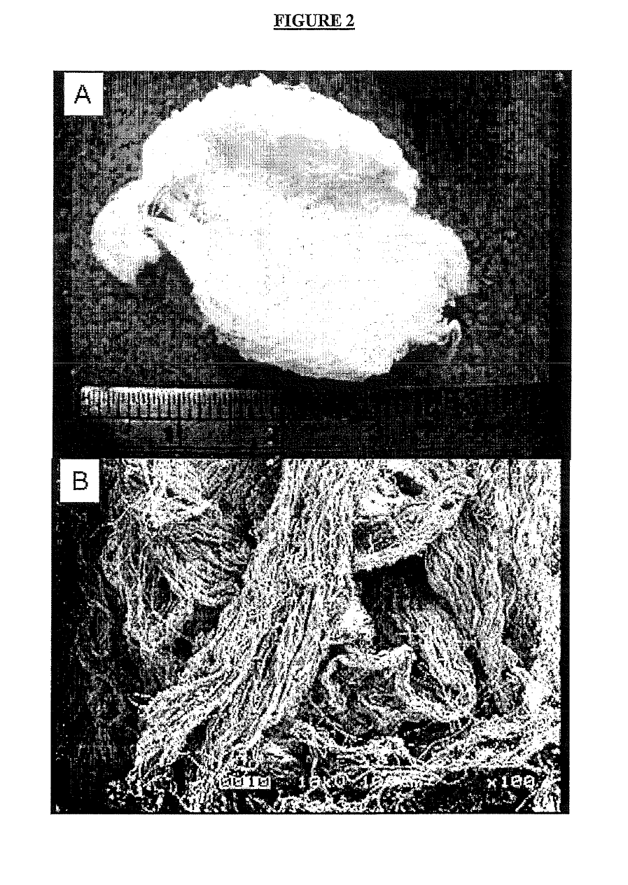

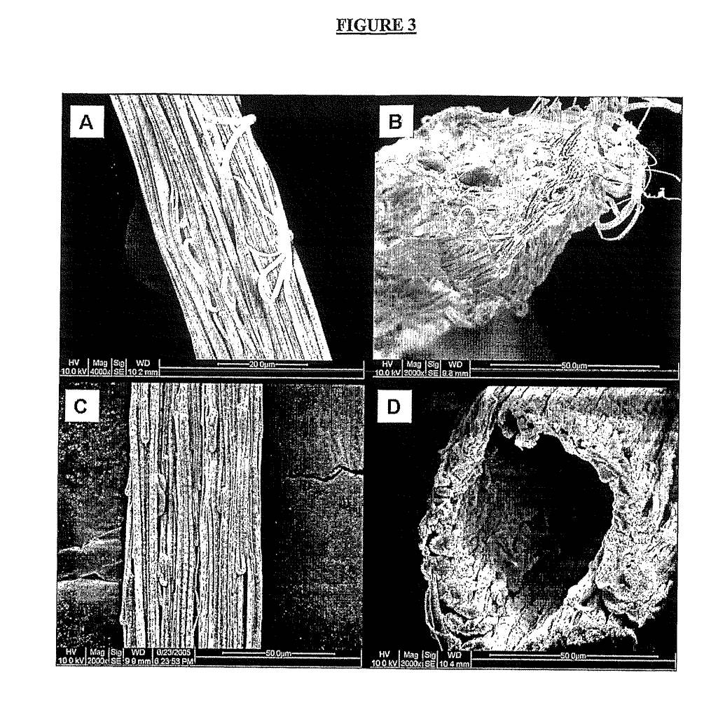

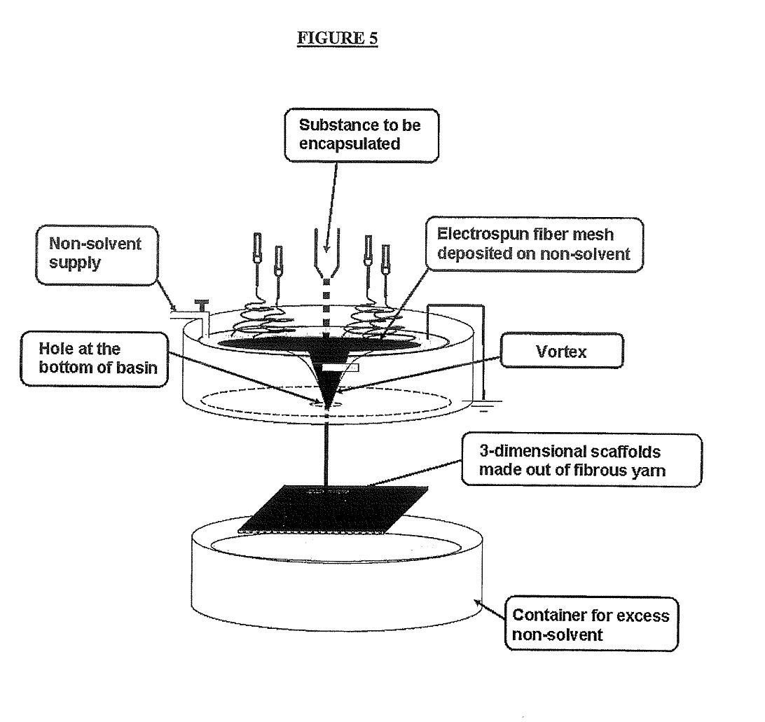

FIGS. 2(A) shows the three-dimensional fiber scaffold formed, while FIG. 2(B) shows the SEM image of the three-dimensional fiber scaffold formed. Other examples of fiber scaffolds formed are shown in FIG. 3. As seen from FIG. 3, either hollow or solid fiber yarn scaffolds may be formed. One way of forming hollow fiber yarn scaffolds is by providing multiple spinnerets surrounding the vortex, for example as shown in FIG. 5. In FIG. 5, the electrospun fibers will be deposited around the sides of vortex. As the non-solvent is being drawn through the vortex and down the hole in the top container, a hollow yarn of fibers is formed. In particular, FIGS. 3(A) and (B) and FIGS. 3(C) and (D) show a fiber scaffold made of poly(vinylidene fluoride) and poly(caprolactone) respectively.

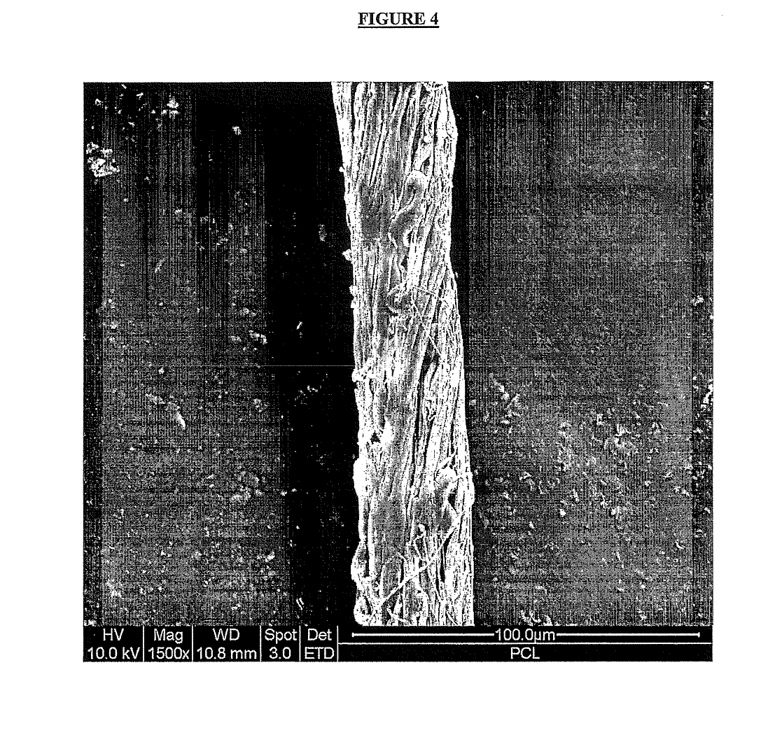

The diameter of the yarn of fibers can be varied by varying the feed rate of viscous material to the spinneret(s), the number of spinnerets used, the diameter of the electrospun fibers that make up the yarn, as well as the speed at which the non-solvent exits through the hole at the bottom surface of the top container. A rapid vortex may be created in the non-solvent in the top container such that the resultant yarn of fibers is twisted as it is being drawn out of the hole at the bottom surface of the top container. An example of such a yarn of fibers formed is shown in FIG. 4.

When more than one spinneret is used, different fibers can be electrospun through different spinnerets so that the fiber scaffold produced will consist of a mixture of electrospun fibers made out of different materials. Depending on the electrospinning condition of each spinneret, electrospun fibers with differing morphology may be mixed to form the fiber scaffold. The spinneret for electrospinning the fibers may be modified to spin core-shell fibers or bi-component fibers.

According to another particular embodiment, shown in FIG. 5, additives may be added to the fiber mesh deposited on the surface of the non-solvent just before it is drawn into the hole at the bottom surface of the top container. The additives may be as described above. In this way, the additives get encapsulated or mixed with the fibers in the fiber mesh as it is drawn into a yarn of fibers and eventually form a fiber scaffold.

In an alternative embodiment, a composite three-dimensional scaffold may be formed by collecting yarns of fibers from different containers and assembling the yarns together, thereby forming a composite fiber scaffold. Alternatively, yarns of fibers, each consisting of different material(s) can be deposited on the collector either simultaneously or consecutively to form a hybrid three-dimensional fiber scaffold.

The container shown in FIGS. 1, 5 and 6 is of cylindrical shape. However, it will be appreciated that the top container containing the non-solvent may be of any suitable shape and size.

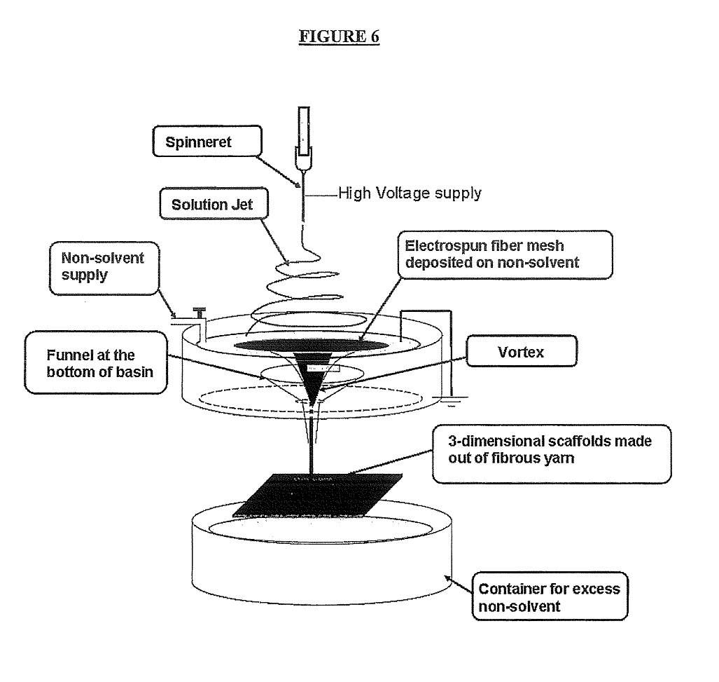

FIG. 6 shows a variation of the set-up shown in FIG. 1. In particular, a funnel is disposed within the top container such that the inlet of the funnel is disposed directly below the spinneret to receive the electrospun fiber. The outlet of the funnel extends through the hole at the bottom surface of the top container. The funnel is used to aid in the creation of vortex fluid flow such that the vortex fluid flow extends into the hole of the top container from which the non-solvent and fiber mesh is drawn. In this way, the fiber mesh is assisted to be drawn into the vortex fluid flow and thereby twist and form the yarn of fibers.

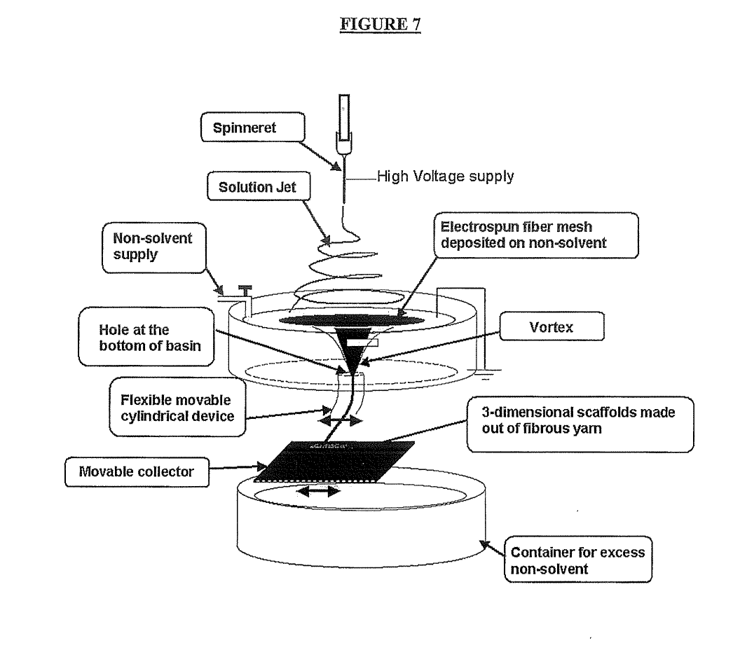

Another variation of the set-up of FIG. 1 is shown in FIG. 7. In particular, the top container comprises a movable flexible device attached to the hole at the bottom surface of the top container. The movable flexible device may be cylindrical. Where the yarn of fibers exits from hole in the top container, the movable device directs the deposition of the yarn of fibers onto the collector. The movable flexible device can be used alone or in conjunction with a movable collector, which can also be used on its own without the use of the movable device, to control the deposition of the yarn of fibers such that an ordered three-dimensional fiber scaffold can be fabricated.

According to another embodiment, auxiliary electrodes may be used to direct the electrospinning jet. For example, the auxiliary electrode is in the form of a ring disposed between the spinneret and the top surface of the top container to thereby distort the electrostatic field surrounding the electrospinning jet as it is emitted from the nozzle of the spinneret. The auxiliary electrode may have a high voltage charge of the same polarity as that of the charge given to the spinneret as shown in FIG. 8.

A different set-up from the one shown in FIGS. 1, 5, 6, 7 and 8 is shown in FIGS. 9 to 14 to form a fiber structure. The fiber structure may be a two-dimensional fiber structure. In particular, FIG. 9 shows a set-up where the non-solvent flows down an inclined slope such that the non-solvent has a first flow rate. A pump may be used to pump the non-solvent from a reservoir of non-solvent to the higher end of the inclined slope. Any suitable non-solvent may be used, as described above. The set-up also comprises a spinneret to provide viscous material in the form of an electrospinning jet when a high voltage is supplied to the viscous material. Any suitable viscous material may be used, as described above. Fibers are formed when the viscous material and the non-solvent on the inclined slope contact each other.

Electrospinning is carried out over the surface of the inclined surface to deposit the fibers on the flowing non-solvent. To facilitate the deposition of the fibers on the inclined surface, an aluminium sheet which is electrically grounded, is submerged in the flowing non-solvent on the inclined surface.

The aluminium sheet is grounded to establish a static electric field between the spinneret and inclined slope and to thereby form a Taylor Cone there between. The grounded aluminium sheet also allows for an electrical pathway to dissipate the electric charge of the formed fibers so that the electrospinning jet is more readily deposited on the surface of the non-solvent on the inclined slope.

The lower end of the inclined slope opens into a collection basin. The non-solvent flowing down the inclined slope flows into the basin together with the formed fibers. In the collection basin, the flow rate of the non-solvent is less than the first flow rate, or is almost zero. In other words, the non-solvent in the basin is substantially stagnant.

The non-solvent flowing along the inclined slope is such that the fibers deposited on the non-solvent surface of the inclined slope during the electrospinning process are immediately carried away into the basin. The fibers are carried either on the surface or just below the surface of the non-solvent into the basin. The speed of the non-solvent flow is sufficiently fast such that the fibers are not allowed to accumulate to form a thick layer as it is carried away by the flowing non-solvent into the basin. Non-solvent flowing into the basin may be re-circulated to the higher end of the inclined slope to flow down the inclined slope again by means of a pump.

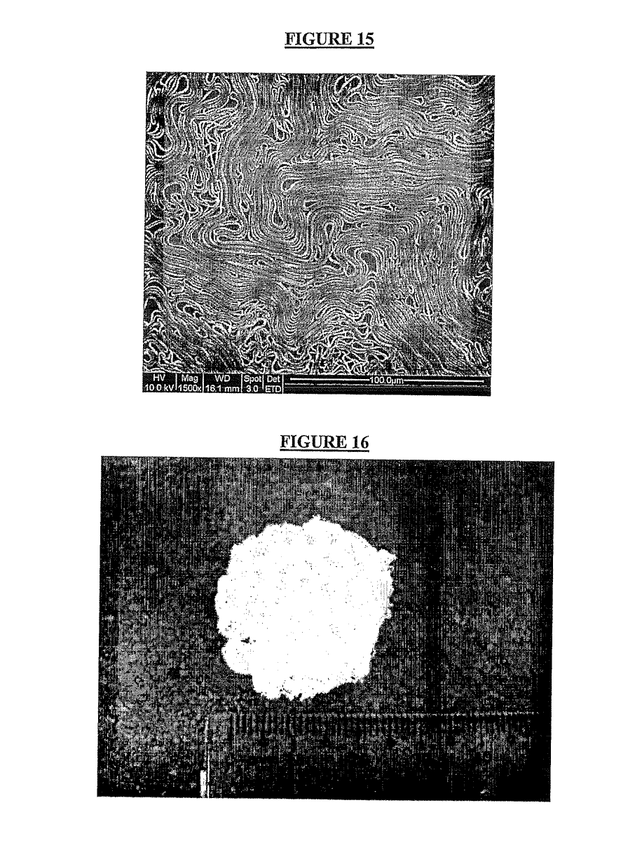

A layer of fibers is eventually formed in the collection basin as more fibers are collected or allowed to collect in the collection basin. An example of the morphology of the layer of fibers collected is shown in FIG. 15. A layer of fibers, as shown in FIG. 15, may be transferred onto a substrate for use as a filter membrane or for use as a substrate for the formation of a thin film.

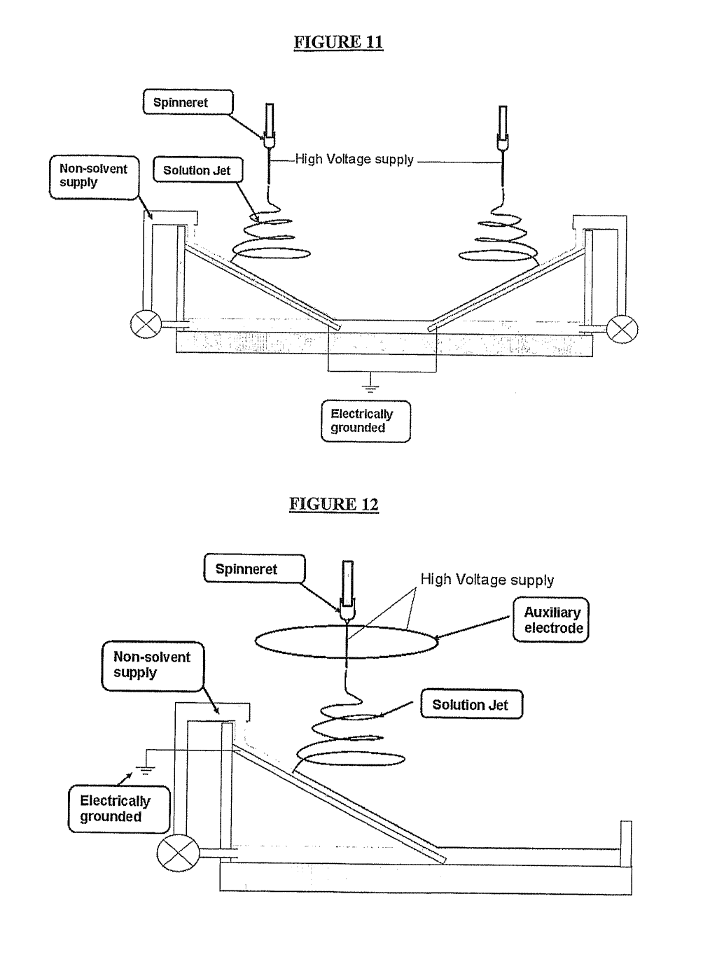

It would be appreciated that the set-up of FIG. 9 may be modified to comprise more than one inclined slope and more than one spinneret. A modified arrangement is shown in FIG. 11, which comprises two inclined slopes and two spinnerets. Each of the inclined slopes leads to a common collection basin.

When more than one spinneret is used, different fibers can be electrospun through different spinnerets so that the layer of fibers formed in the collection basin will consist of a mixture of electrospun fibers made out of different materials. Depending on the electrospinning condition of each spinneret, electrospun fibers with differing morphology may be mixed to form the layer of fibers. The spinneret for electrospinning the fibers may be modified to spin core-shell fibers or bi-component fibers. Alternatively, each spinneret may electrospin fibers different fibers in an alternating manner such that the fiber structure formed in the collection basin comprises alternating layers of fibers of different material.

FIG. 12 shows a modification to the set-up in FIG. 9. In particular, an auxiliary electrode, in the form of a ring, is disposed between the spinneret and the inclined slope to thereby distort the electrostatic field surrounding the electrospinning jet as it is emitted from the nozzle of the spinneret. The auxiliary electrode may have a high voltage charge of the same polarity as that of the charge given to the spinneret.

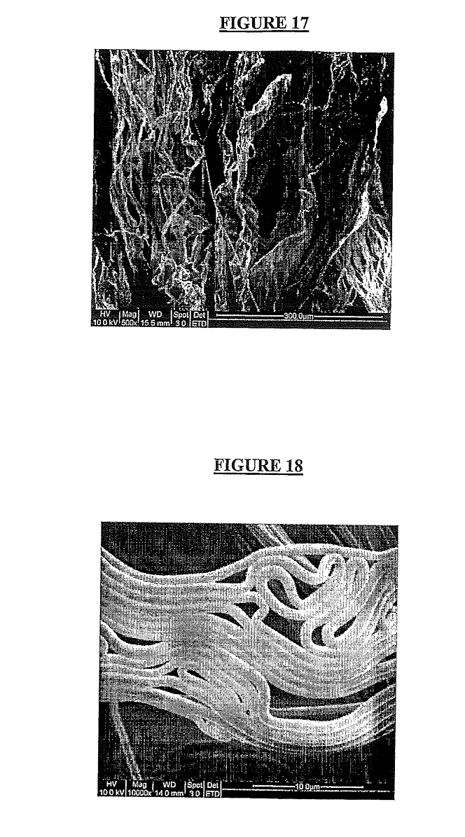

The two-dimensional layer of fibers formed in the collection basin as described above can be easily modified to form a three-dimensional structure, such as a three-dimensional fiber scaffold. For example, the layer of fibers can be removed from the non-solvent and collapsed together to form a three-dimensional fiber scaffold, for example for tissue engineering. The fiber scaffold may be dried under room temperature or it may be re-suspended in a non-solvent and freeze-dried. An example of a three-dimensional fiber scaffold formed is shown in FIGS. 16 to 18. In particular, the three-dimensional fiber scaffold may be for use as a tissue engineering scaffold. Cells may be seeded and/or cultivated on the two-dimensional layers of fibers before the layers are meshed together to form a three-dimensional fiber scaffold so that the cells are encapsulated within the fiber scaffold.

According to alternative embodiments, the set-up of FIG. 9 may be modified such that three-dimensional fiber scaffolds are formed. For example, FIG. 10 shows a set-up similar to that shown in FIG. 9 without the use of an inclined slope. Non-solvent is supplied directly to the collection basin and electrospinning is carried out over the surface of the non-solvent in the collection basin to deposit the electrospun fibers in the collection basin. To facilitate the deposition of the fibers on the non-solvent surface in the collection basin, the non-solvent is grounded. The collection basin comprises a porous mesh such that deposited fibers on the non-solvent surface or just below the surface of the non-solvent collects against the mesh, eventually forming a three-dimensional fiber scaffold. It would be understood that the porous mesh can be replaced with a filter, barrier, wall or the like.

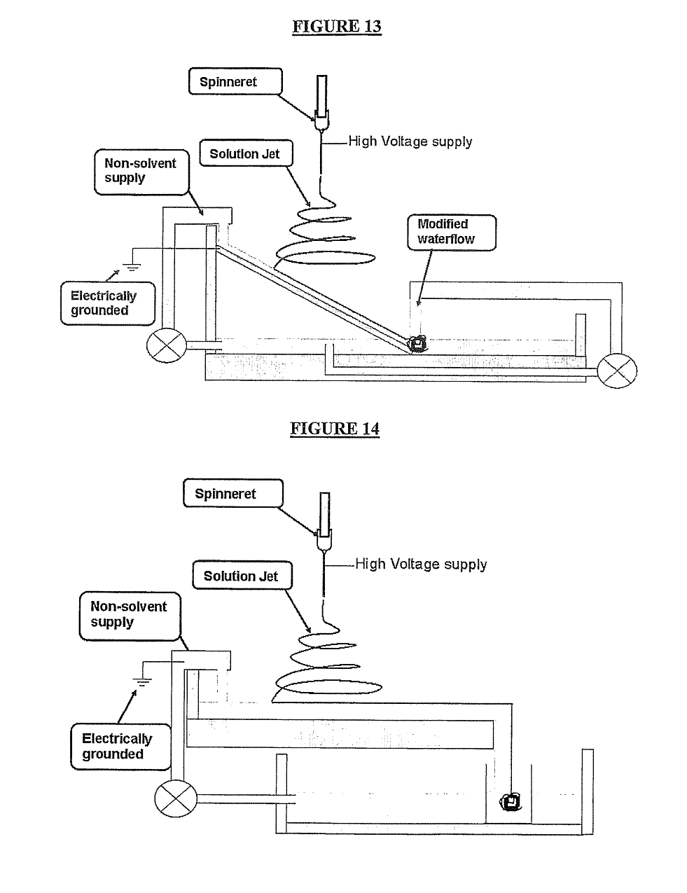

Another arrangement is shown in FIG. 13, which shows a setup where the non-solvent flow is modified from that in FIG. 9 such that a three-dimensional structure is formed through the movement of the non-solvent. The electrospun fibers, which are formed on the surface of the non-solvent or just below the non-solvent along the surface of the inclined slope, flow into the collection basin. A non-solvent flow is introduced into the collection basin in addition to the non-solvent flowing into the collection basin after flowing down the inclined slope. This introduced non-solvent flow into the collection basin is such that it flows into the area where the fibers enter the collection basin, causing the fibers to mesh together to form a three-dimensional fiber scaffold. Non-solvent from the collection basin may be used as the non-solvent flow introduced into the collection basin to form the fiber scaffold by pumping the non-solvent.

FIG. 14 shows an alternative setup similar to that shown in FIG. 10, except that the non-solvent carrying the deposited fibers is allowed to fall over the edge of the collection basin or from an aperture in the collection basin into a tank placed below the collection basin. As in FIG. 10, non-solvent is supplied directly to the collection basin at a first flow rate. Electrospinning is carried out over the surface of the non-solvent in the collection basin. The non-solvent carrying the electrospun fibers in the collection basin is allowed to fall over the edge of the collection basin into a tank. A three-dimensional fibre scaffold is formed in the tank as the fibers accumulate in the tank.

The diameter of the fiber structure prepared according to the present invention may be selected by varying any one or more of the following: (i) the feed rate of the at least one viscous material into the non-solvent during the step of contacting the viscous material with the non-solvent; (ii) the number of spinnerets used to inject the viscous material into the non-solvent; (iii) the diameter of the spinneret injecting the viscous material into the non-solvent; and (iv) the size of a hole provided in the container containing the non-solvent.

### REFERENCES

1. Myung-Seob Khil, Shanta Raj Bhattarai, Hak-Yong Kim, Sung-Zoo Kim and Keun-Hyung Lee. Novel Fabricated Matrix Via Electrospinning for Tissue Engineering. J. Biomed. Mater. Res. Part B: Appl Biomater 2005; 72B: 117-124.
2. Hyun Suk Kim, Kwangsok Kim, Hyoung Joon Jin and In-Joo Chin. Morphological Characterization of Electrospun Nano-Fibrous Membranes of Biodegradable Poly(L-lactide) and Poly(lactide-co-glycolide). Macromol. Symp. 2005; 224: 145-154.
   3. Sian F. Fennessey, Richard J. Farris. Fabrication of aligned and molecularly oriented electrospun polyacrylonitrile nanofibers and the mechanical behavior of their twisted yarns.
4. U.S. Pat, No. 6,106,913 (Frank L. Scardino and Richard J Balonis).
5. U.S. Pat. No. 6,308,509 (Frank L. Scardino and Richard J Balonis).
6. U.S. Pat. No. 6,790,455 (Chu et al).
7. U.S. Pat. No. 6,787,357 (Bowlin et al).
8. US Patent Application No:2004/0018226 (Wnek et al).
9. US Patent Application No:2005/0095695 (Shindler et al).
10. US Patent Application No:2005/0260706 (Kaplan et al).
11. EP Patent Application No :1 591 569 A1 (Kulpinski et al).
12. PCT Publication WO 2007/013858 (Teo et al).
13. U.S. Pat. No. 6,790,528 (Wendorff et al).
14. U.S. Pat. No. 6,616,435 (Lee et al).
15. U.S. Pat. No. 6,713,011 (Chu et al).
16. U.S. Pat. No. 4,043,331 (Martin et al).
17. U.S. Pat. No. 4,878,908 (Martin et al).
18. Son et al, Direct Electrospinning of Ultrafine Titania Fibres in the Absence of Polymer Additives and Formation of Pure Anatase Titania Fibres at Low Temperatures’, Nanotechnology, 11:439-443, 2006.

1. A process of preparing at least one fiber structure comprising the steps of:
(a) contacting at least one viscous material with at least one non-solvent, the non-solvent having a first flow rate; and
(b) allowing formation of the at least one fiber structure in the presence of the non-solvent at a second flow rate, wherein the second flow rate is less than the first flow rate or the second flow rate is about zero.

2. The process according to claim 1, wherein the fiber structure is a layer of fibers.

3. The process according to claim 2, wherein the layer of fibers has a thickness of about one fiber.

4. The process according to claim 1, wherein the fiber structure has a diameter of 100 micron or less.

5. (canceled)

6. The process according to claim 1, wherein the second flow rate is about zero and the step of allowing formation of the fiber structure is performed in the presence of substantially stagnant non-solvent.

7. The process according to claim 1, wherein the first flow rate is obtained by allowing the non-solvent to flow down an inclined plane.

8. The process according to claim 7, wherein the first flow rate of the non-solvent is reduced to the second flow rate after the non-solvent has flowed down the inclined plane to a non-inclined plane, thereby allowing the fiber structure to be formed on the non-inclined plane.

9. A process of preparing at least one fiber structure, wherein the fiber structure is a fiber scaffold, the process comprising the steps of:
(a) contacting at least one viscous material with at least one non-solvent, the non-solvent having a first flow rate; and
(b) obtaining at least one fiber and assembling the obtained fiber(s) to form a fiber scaffold, or obtaining at least one fiber and allowing the obtained fiber(s) to assemble to form of a fiber scaffold.

10. The process according to claim 9, wherein the fiber scaffold is formed by collecting the obtained fiber(s) or by allowing the obtained fiber(s) to collect.

11. The process according to claim 9, wherein the fiber scaffold is formed by collecting the obtained fiber(s) or allowing the obtained fiber(s) to collect against a wall, barrier, mesh and/or filter.

12. The process according to claim 9, wherein the fiber scaffold is prepared by assembling the obtained fiber(s) or allowing the obtained fiber(s) to assemble in the presence of the non-solvent at a second flow rate, wherein the second flow rate is less than the first flow rate or the second flow rate is about zero.

13. The process according to claim 9, wherein the fiber scaffold is prepared by assembling the obtained fiber(s) or allowing the obtained fiber(s) to assemble on a collector.

14. (canceled)

15. (canceled)

16. (canceled)

17. The process according to claim 9, wherein the viscous material comprises a polymer.

18. (canceled)

19. The process according to claim 9, wherein the process further comprises a step of seeding a cell on the fiber structure.

20. (canceled)

21. (canceled)

22. An apparatus for preparing at least one fiber construct, comprising:
(a) means for preparing at least one viscous material;
(b) means for providing at least one flowing non-solvent;
(c) means for contacting or allowing the contact of the viscous material and the non-solvent, thereby allowing the preparation of fiber(s); and
(d) a collector for collecting a fiber structure obtained by assembling the fiber in the form of a fiber structure or for collecting a fiber structure prepared by allowing the fiber to be assembled in the form of a fiber structure.

23. The apparatus according to claim 22, wherein the means for contacting or allowing the contact of the viscous material and the non-solvent further comprises at least one inclined plane for allowing the non-solvent to flow at a first flow rate.

24. The apparatus according to claim 22, wherein the collector comprises at least one non-inclined plane for allowing the fiber(s) to be assembled in the form of a fiber structure in the presence of the non-solvent at a second flow rate, such that the second flow rate is less than the first flow rate or the second flow rate is about zero.

25. (canceled)

26. The apparatus according to claim 22, wherein the apparatus further comprises at least one means for providing a vortex to the non-solvent.

27. The process according to claim 1, wherein the viscous material comprises a polymer.

28. The process according to claim 1, wherein the process further comprises a step of seeding a cell on the fiber structure.
